(19) United States
(12) Patent Application Publication
(10) Pub. No.: US 2026/0091318 A1
(43) Pub. Date: Apr. 2, 2026

(54) INSTANTIATING OBJECTS IN A VIRTUAL SPACE USING MACHINE LEARNING

(71) Applicant: Electronic Arts Inc., Redwood City, CA (US)

(72) Inventors: Anushka Nair, San Mateo, CA (US); Nitish Victor, Redwood City, CA (US); Caedmon Somers, British Columbia (CA); Ashwin Nathan, San Jose, CA (US); Han Liu, Millbrae, CA (US); Jesse Hans Stokes Harder, Oakland, CA (US); Marjan Moodi, Vancouver (CA)

(21) Appl. No.: 18/900,372

(22) Filed: Sep. 27, 2024

(51) Int. Cl. A63F 13/65; G06N 20/00

(52) U.S. Cl. CPC A63F 13/65; G06N 20/00

(57) ABSTRACT

Techniques for instantiating objects in a virtual space are described herein. For example, the techniques may include generating recommended furniture layouts in online games. The game (e.g., an online game) may receive a request to generate a furnished space. The game may identify the current configuration of the space to furnish (e.g., identify existing furniture, door(s), aperture(s), dimension(s) of the space and/or furniture, etc.). Further, the game may receive criteria that describe how to furnish the space (e.g., preferred furniture style, player budget(s), furniture priority, rule(s), etc.). The game may identify characteristics (e.g., furniture types, furniture style, etc.) of other spaces that are proximate to the space to furnish. The game may generate the recommended furnished space by inputting the current configuration of the space, the criteria, and/or the characteristics of the proximate space(s) into a machine learned model which may output a recommended furnished space.

### BACKGROUND

Modern video games include virtual spaces that allow players to play, create, personalize, and share game content with other players via network connectivity. In some examples, these online video game(s) provide vast libraries of virtual game objects for game creation and/or other creative features. However, as these object libraries grow, it becomes more difficult for players to effectively participate in the game creation, as the choices available to players can become overwhelming.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial flow diagram illustrating an example technique for furnishing a space using one or more machine learned models, in accordance with one or more examples of the disclosure.

FIG. 2 illustrates an example computing system including a layout management component configured to generate furnished layouts for various types of spaces, in accordance with one or more examples of the disclosure.

FIG. 3 is an example environment that includes one or more user interface objects used to send requests to generate furnished spaces, in accordance with one or more examples of the disclosure.

FIG. 4 is an example environment that includes a modification to a piece of furniture within a space, in accordance with one or more examples of the disclosure.

FIG. 5 is a flow diagram illustrating an example process for receiving a request to generate a furnished space, determining input data based on the request, generating a recommended furnished space based on the input data and a machine learned model, and causing the recommended furnished space to be displayed via a user device, in accordance with one or more examples of the disclosure.

FIG. 6 illustrates a block diagram of an example system for implementing various techniques described herein.

### DETAILED DESCRIPTION

Techniques for instantiating objects in a virtual space are described herein. For example, the techniques may include generating recommended furniture layouts in an online game. An online game (e.g., an online video game) can include one or more virtual spaces (e.g., virtual interactive environments and/or virtual social spaces) that can be decorated or configured using a number of virtual game objects (hereinafter “object(s)” in short), such as from a library of objects.

As described below, an online game can leverage trained machine learned models to generate furnished layouts for a variety of different spaces (e.g., kitchen(s), living room(s), patio(s), etc.). In some examples, the online game may receive a request to generate a furnished space. That is, a player of the online game may request that the online game provide a recommended furnished space, which includes and/or is made up of a recommended furnished layout, for a specific space among the online game. Based on the request, the online game may identify the current configuration of the space (e.g., identify existing furniture, door(s), aperture(s), dimension(s) of the space and/or of the furniture, etc.). Further, the online game may receive criteria that describe how to furnish the space (e.g., preferred furniture style (or furnishing style), player budget(s), furniture priority, rule(s), etc.). The online game may also identify characteristics (e.g., furniture types, furniture style, etc.) of other spaces that are proximate to the space to furnish. The online game may generate the recommended furnished space by inputting the current configuration of the space, the criteria, and/or the characteristics of the proximate space(s) into a machine learned model which may provide, as output, a recommended furnished space.

The online game can cause the recommended furnished space to be displayed via a user interface of or at a user or player device used by the player. As described in more detail below, the techniques described herein may improve the online game and/or the player experience by facilitating creativity such that the player is able to more efficiently or effectively engage with the online game functionality.

When playing an online game, it may be beneficial to facilitate player creativity such that the player enjoys their game experience. For example, an online game may allow a player to customize (or furnish) various types of spaces (e.g., bedroom(s), living room(s), kitchen(s), patio(s), backyard(s), commercial structure(s) or space(s), etc.). For instance, the player can determine which types of furniture and/or décor to place at various locations within the space. However, in some circumstances, the player may lack ideas regarding how to start furnishing the empty space. That is, empty spaces may cause a creative block in the player which may result in the player not enjoying the online game. Accordingly, the systems and/or techniques described herein include leveraging machine learned model(s) to provide recommendations and/or inspiration to the player as to how the user can furnish a particular space.

To address these and other technical problems and inefficiencies, the systems and/or techniques described herein include a layout management component (also referred to as a “layout manager” or “layout management system”) configured to display furnished space layouts. Technical solutions discussed herein solve one or more problems associated with a suboptimal player experience. Further, the technical solutions can reduce messages across the network and may reduce server load. For example, players may spend an inordinate amount of time browsing through catalogues of candidate spaces and/or candidate furniture, and structuring a restructuring a room. Each interaction with the catalogue or space may cause corresponding messaging to be sent via a network and may cause a server to respond. Thus, by expediting initial setup the techniques may reduce server load and network traffic.

In some examples, a gaming system may train machine learned model(s) to output furnished spaces. That is, the gaming system may be an offline system (or component) that is configured to train one or more machine learned models to generate recommended furnished spaces. In some examples, the gaming system may receive the training data which may be historical data. Historical data can include furnished spaces that were created by one or more other players of the online game at a previous time. A space may be a bedroom, a living room, a kitchen, a playroom, a patio, a backyard, a commercial space, etc. The spaces may include one or more types (or classification(s)) of furniture and/or décor organized in various configurations. Further, the spaces and/or the furniture included therein may include one or more classifications, styles, costs, stylistic requirements or guidelines, etc. The gaming system may also receive rule(s) associated with furnishing spaces. Such rules may indicate that furniture may not overlap, budgets must be followed, etc.

Based on receiving the historical data and/or the rules, the gaming system may use such data to train one or more machine learned models. In some examples, the gaming system may train a single machine learned model for each type of space. That is, the gaming system may train a first machine learned model to generate furnished layouts for living rooms, a second (and separate) machine learned model to generate furnished layouts for bedrooms, a third (and separate) machine learned model to generate furnished layouts for patios, etc. In such cases, the machine learned models may be trained on the historical data that corresponds thereto. For example, the gaming system may train the first machine learned model on living rooms in the historical data, the second machine learned model on bedrooms in the historical data, and/or the third machine learned model on patios in the historical data. However, this is not intended to be limiting; in other examples, the gaming system may train a single machine learned model to generate furnished layouts for all types of spaces.

In some examples, the gaming system may train the machine learned model(s) using the historical data. The historical data can include tags or labels that identify the type of space (e.g., living room, bedroom, etc.), the type(s) of furniture within the space, the price of such furniture, the dimensions or ratios (e.g., width, height, length, etc.) of the space and/or furniture included therein, the footprint (e.g., area required for the furniture) or required space associated with the furniture, the priority of the furniture (e.g., certain types of furniture can be higher priority based on the room type (e.g., bed may be highest priority in a master bedroom)), player budget(s) for the space, etc. In some cases, after training the machine learned model(s), the gaming system may send the trained machine learned models to one or more online games such that the online game(s) may use the machine learned model(s) while player(s) are engaging with the online game.

From the perspective of the online game, the online game may receive a request to access the online game. A player may use a player or user device such as a mobile device, desktop device, wearable, and/or other computing devices of the like to access and/or interact with the online game. The player may input credentials to the online game to access the game, such as through a user or player account.

In some examples, the online game (or the layout management component) may receive a request to generate a furnished space. The online game may be a space furnishing game that allows a player to organize the layout of furniture and/or décor within the space. In some examples, the user may engage with and/or organize the space via the player or user device. That is, the online game may include one or more user interface objects (e.g., buttons, windows, etc.) that are configured to perform a function. In this case, one of the user interface objects may be associated with a request to generate a furnished space. That is, the player may select the user interface object (e.g., touch the button, select the button, etc.) which may send a request to the layout management component to generate a furnished space. The request may include player profile data, a space identifier, space data, etc. Additionally or alternatively, the request may include an instruction to generate a newly furnished space (e.g., all new furniture in the room) or an instruction to generate a furnished space that incorporates the furniture already in the space.

Based on the request, the layout management component may identify (or determine) a current configuration of the space. The current configuration may include a dimension and/or ratio of the space (e.g., width, height, length, corner points, boundary, etc.), locations and/or dimensions of door(s) and/or aperture(s), current furnishing(s) (e.g., existing furniture size, type (or classification), dimension, ratio, location, orientation, etc.), etc. As noted below, the current configuration data may be an input to the machine learned model.

Further, the layout management component may identify criteria associated with furnishing the space. Criteria may include a style, a budget, a priority, a number of furniture pieces to include in the space, a requested type of furniture to include in the space, a rule associated with furnishing the space (e.g., a furnishing rule), etc.

For example, for the style criteria, the player may prefer and/or request a certain type of style. That is, the player may indicate that the recommended furnished space is to include furniture that conforms to a particular style such as western, beach, mountain, etc.

Further, for the budget criteria, when playing the online game, the player may have a budget with which they can furnish the space. As such, when generating the recommended furnished space, the machine learned model(s) may consider the available budget of the player. For example, when generating a recommendation with a limited budget remaining, the machine learned model may select lower cost furniture such that a space may be fully furnished. Accordingly, the player budget may impact which furniture is included in the recommended furnished space.

Further, for the priority criteria, each type of space may include a list of prioritized types of furniture to include in the space. That is, to ensure that the correct types of furniture are being included in the space, the system can identify a priority of the furniture to include in the space. As an example, in a bedroom, a bed may be the highest priority and a sink may be the lowest priority. Accordingly, when determining which furniture to include in the space, the machine learned model may prioritize the types of furniture that are of the highest priority that are not already included in the space.

As for the quantity of furniture pieces criteria, the player may request a particular number of furniture pieces. For instance, the player may request that the recommended furnished space include 10 pieces of furniture. In this case, the quantity of requested furniture pieces may be used when determining which pieces of furniture to include in the furnished space that also satisfy the budget, the style, the prioritization, etc. Further, in some cases, the player may request that certain types of furniture be included in the space. That is, the player may request that a specific type of furniture be added to a room. For example, the player may indicate that they want the machine learned model to recommend a sofa to include in the partially furnished space.

As for the rule(s) criteria, the online game may include rules that describe how a space can be organized or configured. For example, a space may not include intersecting or overlapping furniture. That is, every piece of furniture may include a footprint that defines the physical space occupied by the furniture in addition to a buffer zone (e.g., 24 inches of space required at the foot of a bed, 36 inches of space required along the seating portion of a sofa, etc.) of the environment surrounding the furniture. As such, when generating the recommended furnished space, the machine learned model may ensure that the recommendation satisfies the rule(s) and that none of the furniture overlap in footprints.

In some examples, the layout management component may identify characteristics of one or more spaces that are proximate to the space to furnish. That is, in some cases, the player may be requesting to furnish a space that is part of a structure (e.g., home, shed, etc.) that has one or more levels (or stories) and/or one or more spaces (or rooms). In such cases, the layout management component may identify the spaces that are proximate to the space to furnish and use such information when furnishing the space. A space may be proximate the space to furnish if the space is within a threshold distance from the space to furnish, adjacent to the space to furnish, and/or on the same level (or floor) as the space to furnish. In such cases, the layout management component may identify the characteristics of such proximate spaces. The characteristics may include the types and/or styles of furniture included in such spaces. As noted, the machine learned models may use the characteristics to increase the consistency and/or cohesiveness of the spaces within the structure. That is, the style and/or furniture in the proximate space(s) may impact the furniture used in the recommended furnished space.

In some examples, the layout management component may input the current configuration, the criteria, and/or the characteristics into a machine learned model. The online game may receive the trained machine learned models that were trained offline by the gaming system. In this case, the trained machine learned models may include one or more generative machine learned models. Accordingly, the layout management component may input the current configuration, the criteria, and/or the characteristics of the proximate space(s) into the machine learned model which may be trained to output the furnished space. The machine learned model may be configured to analyze the various inputs and generate a recommend furnished space that conforms to the criteria and/or satisfies the request.

In some examples, the layout management component may receive output data that represents the recommended furnished space from the machine learned model. The output data can include the space type (or classification), the space dimension(s), the types (or classifications) of furniture included in the space, the size and/or dimension(s) of the furniture, the position and/or orientation of the furniture in the space, etc.

In some examples, the layout management component may cause the recommended furnished space to be displayed via a user interface of a player or user device of the player. That is, the layout management component may display the furnished space to the requesting player. In some cases, the layout management component may use the output data from the machine learned model to know where and/or how to render the furnished space. In some cases, the furnished space may be displayed on the same or separate user interface from the user interface used to request the furnished space.

Additionally or alternatively, the player may request to modify one or more pieces of furniture in the space. That is, after displaying the recommended furnished space, the player may request to modify the recommended furnished space by moving furniture, changing the color or appearance of the furniture, adding furniture to the space, removing furniture from the space, etc. In such cases, the layout management component may allow the requested modification if the modification complies or satisfies the rules of the online game. For example, the online game may include a rule that certain types of furniture may not have overlapping footprints. As such, the layout management component may determine where the player is requesting the move the furniture and determine whether the footprint overlaps with the footprint of other furniture in the space. If the modification satisfies the rules, the layout management component may allow the modification and cause the modification to occur.

Although discussed in the context of furnishing rooms, the techniques discussed herein may be applicable to a variety of games and virtual spaces, such as skate parks, amusement parks, hospitals, commercial buildings, etc.

Certain implementations and embodiments of the disclosure will now be described more fully below with reference to the accompanying figures, in which various aspects are shown. However, the various aspects may be implemented in many different forms and should not be construed as limited to the implementations set forth herein. It will be appreciated that the disclosure encompasses variations of the embodiments, as described herein. Like numbers refer to like elements throughout.

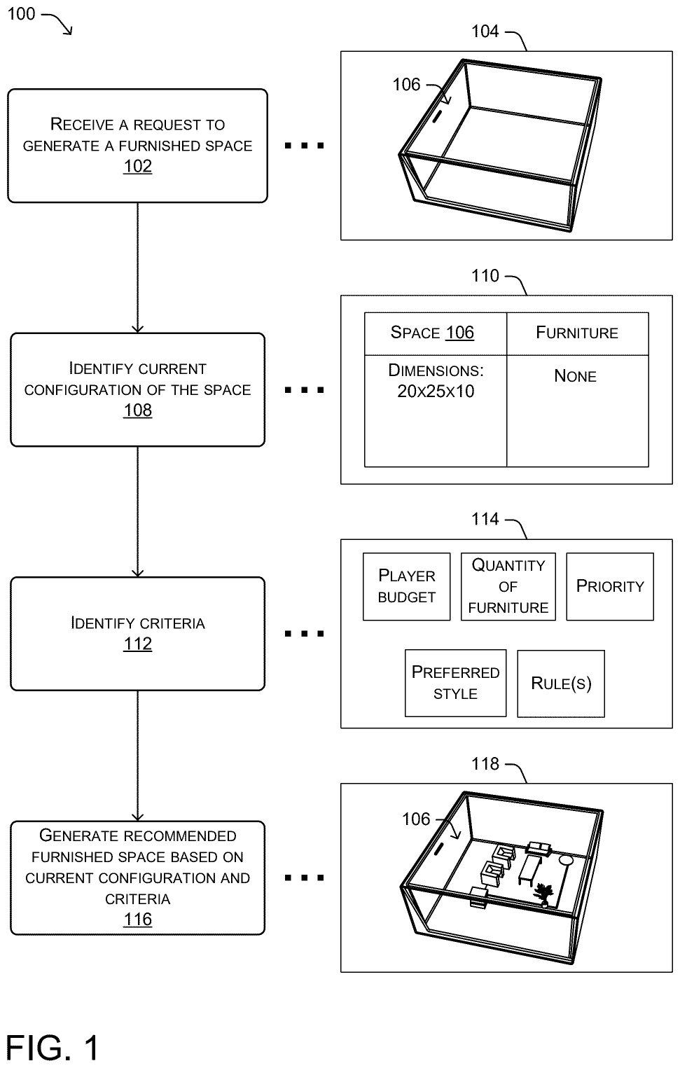

FIG. 1 is a pictorial flow diagram illustrating an example process 100 for furnishing a space using one or more machine learned models. As described below, the example process 100 may be performed by a layout management component.

At operation 102, the layout management component may receive a request to generate a furnished space. In some examples, a player may be playing an online game via a player or user device. The online game may enable the player to design and/or organize the furniture and/or décor within the bounds of a space. When organizing (or furnishing) the space, the player may request that the online game provide a recommended furnished space. For example, box 104 illustrates a space in the online game. In this example, the box 104 may include a space 106 which may be a living room; however, in other examples, the space 106 may be a bedroom, patio, backyard, kitchen, etc. The player may select a button (not shown) on the user interface which may send a request to the layout management component to provide a recommended furnished layout of the space 106.

At operation 108, the layout management component may identify a current configuration of the space 106. That is, based on receiving the request at operation 102, the layout management component may determine the size and/or dimensions of the space 106, the furniture already in the space 106, data associated with the furniture (e.g., location, orientation, size, ratio, etc.), etc. For example, box 110 illustrates data describing the current configuration of the space 106. In this example, the box 110 includes a table that includes a column providing data regarding the space. Such data may include the dimensions of the space 106. In this example, the dimensions of the space 106 may be 20×25×10 (feet or meters or any unit). Further, the table may include data regarding the current configuration of the furniture within the space 106. As shown in box 104 and box 110, the space 106 may lack furniture (e.g., the space 106 is empty) and as such, the table in box 110 may indicate that the current configuration does not include furniture.

At operation 112, the layout management component may identify criteria used to describe how the space 106 may be furnished. That is, the layout management component may receive criteria which may impact which types of furniture and/or what quantity of furniture to include in the furnished space. For example, box 114 illustrates various types of criteria that may impact the selection of furniture to include in the space 106. In this example, the box 114 may include one or more boxes which may include data associated with a type of criteria. The box 114 may include a player budget box, a quantity of furniture box, a priority box, a preferred style box, and/or a rule(s) box.

The player budget box may include the remaining budget available to the player for furnishing the space. That is, when playing the online game, the player may have a finite budget to furnish the space. As such, the player budget box may include the budget available to the player. The quantity of furniture box may include information regarding how many pieces of furniture to include in the furnished space. In such cases, the player may request a specific number of furniture pieces to include in the space. The priority box may include a list of furniture that may be prioritized based on the type of space. That is, the priority box may include a different list of prioritized furniture items for living rooms than for bedrooms. As an example, a sink may be the highest priority for a kitchen whereas a master bed may be the lowest priority for the kitchen. The preferred style box may include the style of furniture to include in the space 106. That is, the player may request a specific style of furniture be included in the space 106. As such, when generating the furnished space, the layout management component may retrieve furniture that conforms to (or satisfies) the style request. The rule(s) box may include one or more rules of the online game that define how the space 106 may be furnished. That is, the online game may include rule(s) that the layout management component is to follow when furnishing the space 106. In some examples, a rule may be that the footprint of a piece of furniture may not overlap with the footprint of a different piece of furniture. As such, the layout management component may retrieve the various types of criteria and use such data when generating the furnished space.

At operation 116, the layout management component may generate a recommended furnished space based on the current configuration and/or the criteria. The layout management component may include one or more machine learned models that are trained to output furnished spaces. That is, the machine learned models may be trained on historical data that may include furnished spaces created by other players of the online game at a previous time. In some cases, the online game may include a machine learned model uniquely trained for each type of space. For instance, the online game may include a machine learned model trained to generate furnished spaces for bedrooms, a separate machine learned model trained to generate furnished spaces for kitchens, a separate machine learned model trained to generate furnished spaces for patios, etc. As such, the online game may analyze the request and/or the current configuration to determine which machine learned model to use. Based on identifying the machine learned model to use based on the space classification, the layout management component may input the current configuration data and/or the criteria into the machine learned model which may provide, as output, a furnished space. For example, box 118 illustrates the space 106 furnished with one or more types of furniture. In this example, the space 106 may include multiple sofas, a table, a plant, and/or one or more other items. The furniture may be rendered at a specific location and/or orientation based on the data output by the machine learned model. In some cases, the player may be able to interact with and/or modify the configuration and/or organization of the furniture included in the space 106.

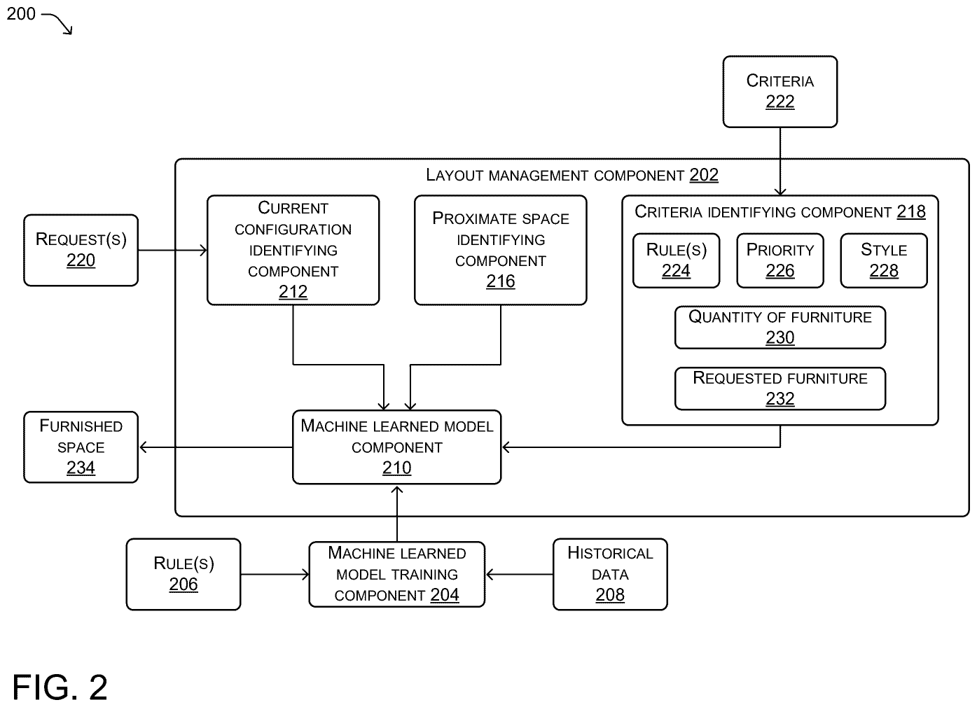

FIG. 2 illustrates an example computing system 200 including a layout management component 202 configured to generate furnished layouts for various types of spaces. In some cases, the example computing system 200 may be associated with a user or player device. As such, the layout management component 202 and the operations described therein may be incorporated in the user or player device (e.g., the models within the layout management component 202 may operate locally on a player device during runtime of the online game). Alternatively or additionally, the example computing system 200 may be associated with a service or a server that is external to the player device and may be communicatively coupled to the user or player device interacting with the online game. That is, the example computing system 200 may operate separately from user or player device while the player is playing the online game.

In this example, the example computing system 200 may include a machine learned model training component 204 which may be configured to train one or more machine learned models to generate furnished spaces. The machine learned model training component 204 may operate offline or separate from the online game. That is, the machine learned model training component 204 may train the machine learned models offline and send the trained models to the online game (or the layout management component 202) after training.

As shown, the machine learned model training component 204 may receive rule(s) 206 and/or historical data 208. The rule(s) 206 may define how the layout management component 202 is to furnish a space. The rule(s) 206 may include that multiple pieces of furniture may not overlap in footprint. The historical data 208 may include furnished spaces that were created by a player of the online game at a previous time. The historical data 208 may be organized by the type of space. Accordingly, the machine learned model training component 204 may train separate machine learned models for each type of space. That is, the machine learned model training component 204 may train a machine learned model to furnish bedrooms with the bedrooms in the historical data 208, a separate machine learned model to furnish kitchens with the kitchens in the historical data 208, etc. As such, the machine learned model training component 204 may use the rule(s) 206 and/or the historical data 208 to train the machine learned model(s). The machine learned model training component 204 may send the trained machine learned models to the machine learned model component 210 which may be configured to generate furnished spaces.

As shown, the layout management component 202 may include one or more subcomponents such as a current configuration identifying component 212 configured to identify the current configuration of a space, a proximate space identifying component 216 configured to identify characteristics of a space proximate to the space to furnish, a criteria identifying component 218 configured to identify (or receive) criteria to use when generating the furnished space, and/or the machine learned model component 210 configured to generate furnished spaces.

In some examples, the layout management component 202 may include a current configuration identifying component 212 configured to identify the current configuration of a space. That is, the current configuration identifying component 212 may receive a request 220 from a player or user device. However, this is not intended to be limiting; in other examples, the request 220 may be received by any other component of the layout management component 202. The request 220 may include instructions to generate a furnished space. As such, the current configuration identifying component 212 may identify the current configuration of the space the player requested to furnish. The current configuration may include the size and/or dimension of the space, the location and/or size of the door(s), window(s), and/or aperture(s) of the space, the furniture size, shape, location, orientation that is currently in the space, etc.

In some examples, the layout management component 202 may include a proximate space identifying component 216 configured to identify characteristics of a space proximate to the space to furnish. That is, when generating the furnished space, the machine learned model component 210 may consider the type(s) and/or style(s) of the furniture in adjacent spaces such that the furnished space is cohesive with the rest of the structure. As such, the proximate space identifying component 216 may identify one or more spaces proximate the space to furnish. A space may be proximate based on the space being within a threshold distance to the space to furnish, being on the same level as the space to furnish, etc. In such cases, the proximate space identifying component 216 may retrieve the data or characteristics (e.g., furniture type(s), furniture style(s), etc.) associated with such spaces.

In some examples, the layout management component 202 may include a criteria identifying component 218 configured to identify (or receive) criteria to use when generating the furnished space. As shown, the criteria identifying component 218 may receive criteria 222 which may include one or more types of criteria. As shown, the types of criteria may include rule(s), priority, style, quantity of furniture, requested furniture, etc. In this example, the criteria identifying component 218 may include one or more subcomponents which may be trained to receive, store, synchronize, and/or analyze the criteria 222. For example, the criteria identifying component 218 may include a rule(s) component 224 that may be configured to receive, store, synchronize, and/or analyze the rule(s) of the criteria 222, a priority component 226 that may be configured to receive, store, synchronize, and/or analyze the prioritization of furniture for specific types of spaces as indicated in the criteria 222, a style component 228 that may be configured to receive, store, synchronize, and/or analyze the requested or preferred style of the player, a quantity of furniture component 230 that may be configured to receive, store, synchronize, and/or analyze the number of furniture items to include in the space, and/or a requested furniture component 232 that may be configured to receive, store, synchronize, and/or analyze the one or more types (or classifications) of furniture requested by the player.

In some examples, the layout management component 202 may include the machine learned model component 210 configured to generate furnished spaces. The machine learned model component 210 may receive the current configuration data from the current configuration identifying component 212, the characteristics of a space proximate the space to furnish, and/or the criteria 222. In such cases, the machine learned model component 210 may analyze such data and generate a furnished space 234. That is, the machine learned model component 210 may use the trained machine learned model from the machine learned model training component 204 to output a furnished space 234 to the requesting player. In such cases, the furnished space 234 may be displayed via a user interface of a player or user device as used by the player.

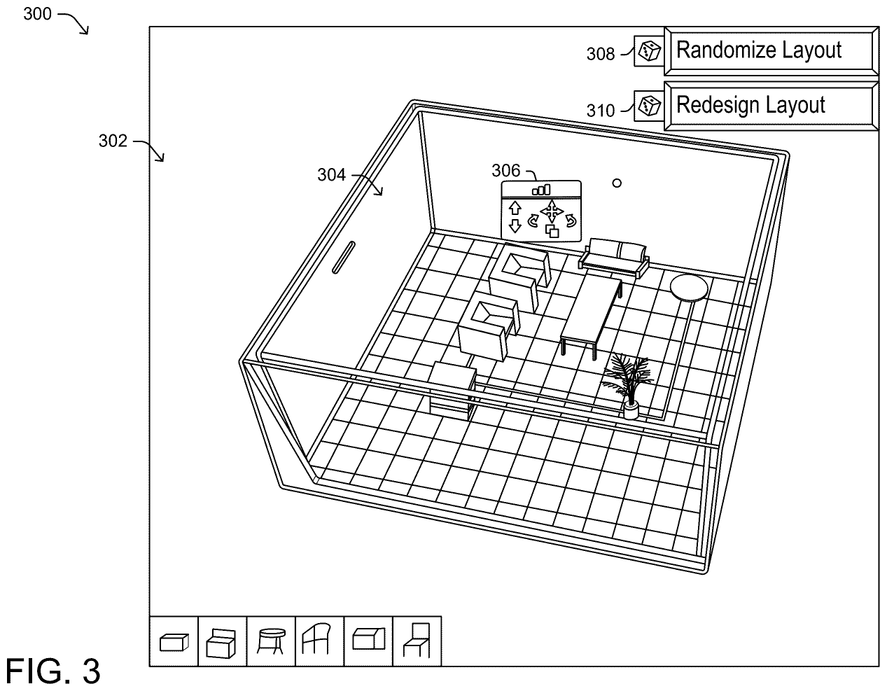

FIG. 3 is an example environment 300 that includes one or more user interface objects used to send requests to generate furnished spaces.

In this example, the example environment 300 may include a user interface 302 which may include or otherwise display a space 304. As noted above, the user interface 302 may be displayed via a player or user device of a player of the online game. In this case, the player may interact with the space 304 via the user interface 302. As shown, the space 304 may be a living room; however, in other examples, the space 304 may be any other type of space such as a bedroom, kitchen, patio, backyard, etc. The space 304 may include one or more pieces of furniture such as a table, one or more chairs or sofas, plants, etc. In some examples, the user interface 302 may include a user interface object 306 to allow the player to modify the location and/or orientation of the furniture, etc.

In some examples, the player playing the online game via the user interface 302 may request that the online game generate a recommended furnished space. The player may send the request by selecting one or more of the user interface objects displayed via the user interface 302. That is, the user interface 302 may include a user interface object 308 and a user interface object 310. The user interface object 308 may be an actionable button that, upon selection, may cause a request to be sent to the online game to generate a furnished space. In this example, the request associated with the user interface object 308 may include an instruction to generate a new furnished space that disregards the furniture already in the space 304. In contrast, the user interface object 310 may be an actionable button that, upon selection, may cause a request to be sent to the online game to generate a furnished space. In this example, the request associated with the user interface object 310 may include an instruction to generate a furnished space that incorporates the furniture already in the space 304.

When generating the recommended furnished space, the online game may identify the current configuration of the space 304. The current configuration of the space 304 may include the number of furniture items in the space 304, the types of furniture in the space 304, the locations of the furniture in the space 304, the orientations of the furniture in the space 304, the dimensions and/or boundary of the space 304, the dimension and/or locations of doors and/or apertures of the space 304, etc. In such cases, the online game may input such information into a machine learned model which may be trained to output a recommended furnished space.

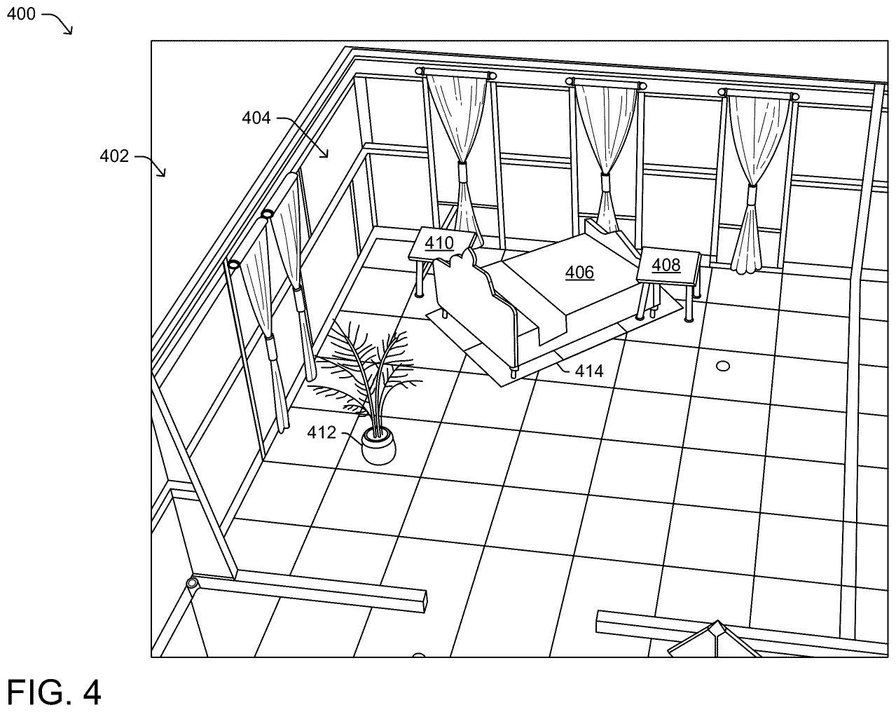

FIG. 4 is an example environment 400 that includes a modification to a piece of furniture within a space.

In this example, the example environment 400 may include a user interface 402 which may include or otherwise display a space 404. As noted above, the user interface 402 may be displayed via a player or user device of a player of the online game. In this case, the player may interact with the space 404 via the user interface 402. As shown, the space 404 may be a room within a home, hotel, or the like. The space 404 may include various types of furniture that include a bed 406, a nightstand 408, a nightstand 410, a plant 412, among other objects. However, this is not intended to be limiting; in other examples, the furniture may be of a different classification.

In this example, the layout management component may receive a request from the player to modify the configuration of one or more objects in the space 404. That is, the player may request to modify the orientation of the bed 406. As described above, the layout management component may allow modifications when such modifications satisfy the rule(s) of the online game. In some cases, a rule may describe that the footprint of multiple pieces of furniture may not overlap. Accordingly, the layout management component may determine whether the footprint of two or more objects overlap. In this example, the bed 406 may include the footprint 414. As shown, the footprint 414 may cover a region of the space 404 associated with the bed 406 in addition to a buffer zone around the boarder of the bed 406. In this example, the layout management component may determine that the footprint 414 of the bed 406 may overlap with the area occupied by the nightstand 408. As such, in this example, the layout management component may determine that the modification requested by the player violates the rule(s) and as such, the layout management component may reject the modification. Of course, the player may modify the orientation of the bed 406 such that the footprint 414 does not overlap with the area occupied by the nightstand 408 and in such situations, the layout management component may approve the modification and cause the modification to occur.

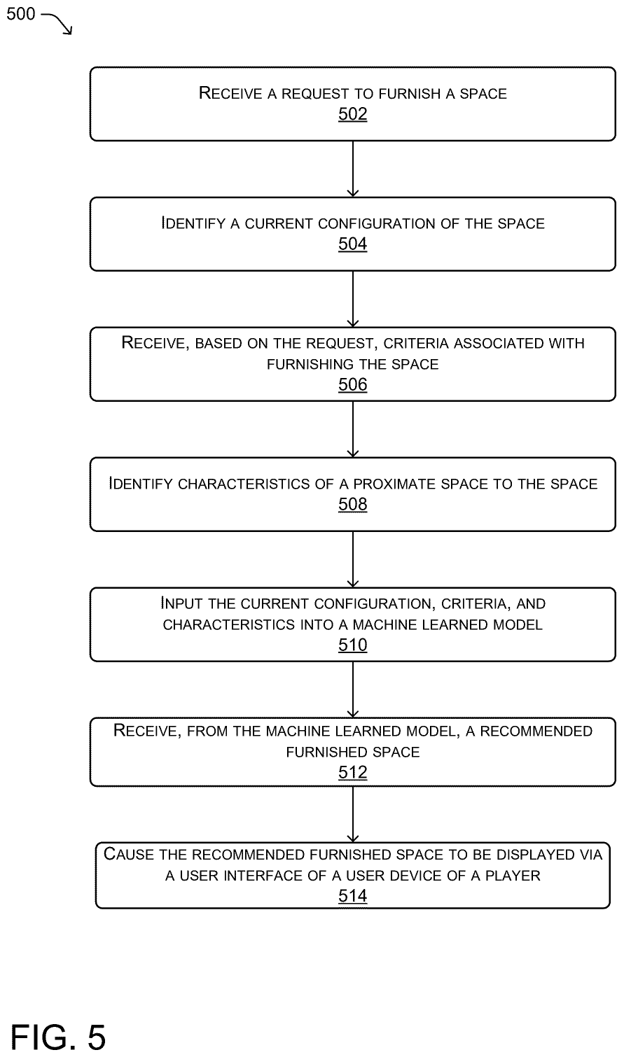

FIG. 5 is a flow diagram illustrating an example process 500 for receiving a request to generate a furnished space, determining input data based on the request, generating a recommended furnished space based on the input data and a machine learned model, and causing the recommended furnished space to be displayed via a user device. As described below, the example process 500 may be performed by a layout management component 202. The order in which the operations are described should not be construed as a limitation. Any number of the described blocks can be combined in any order and/or in parallel to implement the processes, or alternative processes, and not all of the blocks need to be executed in all examples.

At operation 502, the layout management component may receive a request to furnish a space. The online game may be a space furnishing game that allows a player to organize the layout of furniture and/or décor within the space. In some examples, the user may engage with and/or organize the space via the user device. That is, the online game may include one or more user interface objects (e.g., buttons, windows, etc.) that are configured to perform a function. In this case, one of the user interface objects may be associated with a request to generate a furnished space. That is, the player may select the user interface object (e.g., touch the button, select the button, etc.) which may send a request to the layout management component to generate a furnished space. The request may include player profile data, a space identifier, space data, etc. Additionally or alternatively, the request may include an instruction to generate a newly furnished space (e.g., all new furniture in the room) or an instruction to generate a furnished space that incorporates the furniture already in the space.

At operation 504, the layout management component may identify a current configuration of the space. The current configuration may include a dimension and/or ratio of the space (e.g., width, height, length, corner points, boundary, etc.), locations and/or dimensions of door(s) and/or aperture(s), current furnishing(s) (e.g., existing furniture size, type (or classification), dimension, ratio, location, orientation, etc.), etc. As noted below, the current configuration data may be an input to the machine learned model.

At operation 506, the layout management component may receive, based on the request, criteria associated with furnishing the space. Criteria may include a style, a budget, a priority, a number of furniture pieces to include in the space, a requested type of furniture to include in the space, a rule associated with furnishing the space, etc.

For example, for the style criteria, the player may prefer and/or request a certain type of style. That is, the player may indicate that the recommended furnished space is to include furniture that conforms to a particular style such as western, beach, mountain, etc.

Further, for the budget criteria, when playing the online game, the player may have a budget with which they can furnish the space. As such, when generating the recommended furnished space, the machine learned model(s) may consider the available budget of the player. For example, when generating a recommendation with a limited budget remaining, the machine learned model may select lower cost furniture such that a space may be fully furnished. Accordingly, the player budget may impact which furniture is included in the recommended furnished space.

Further, for the priority criteria, each type of space may include a list of prioritized types of furniture to include in the space. That is, to ensure that the correct types of furniture are being included in the space, the system can identify a priority of the furniture to include in the space. As an example, in a bedroom, a bed may be the highest priority and a sink may be the lowest priority. Accordingly, when determining which furniture to include in the space, the machine learned model may prioritize the types of furniture that are of the highest priority that are not already included in the space.

As for the quantity of furniture pieces criteria, the player may request a particular number of furniture pieces. For instance, the player may request that the recommended furnished space include 10 pieces of furniture. In this case, the quantity of requested furniture pieces may be used when determining which pieces of furniture to include in the furnished space that also satisfy the budget, the style, the prioritization, etc. Further, in some cases, the player may request that certain types of furniture be included in the space. That is, the player may request that a specific type of furniture be added to a room. For example, the player may indicate that they want the machine learned model to recommend a sofa to include in the partially furnished space.

As for the rule(s) criteria, the online game may include rules that describe how a space can be organized or configured. For example, a space may not include intersecting or overlapping furniture. That is, every piece of furniture may include a footprint that defines the physical space occupied by the furniture in addition to a buffer zone (e.g., 24 inches of space required at the foot of a bed, 36 inches of space required along the seating portion of a sofa, etc.) of the environment surrounding the furniture. As such, when generating the recommended furnished space, the machine learned model may ensure that the recommendation satisfies the rule(s) and that none of the furniture overlap in footprints.

At operation 508, the layout management component may identify characteristics of a proximate space to the space. That is, in some cases, the player may be requesting to furnish a space that is part of a structure (e.g., home, shed, etc.) that has one or more levels (or stories) and/or one or more spaces (or rooms). In such cases, the layout management component may identify the spaces that are proximate to the space to furnish and use such information when furnishing the space. A space may be proximate the space to furnish if the space is within a threshold distance from the space to furnish, adjacent to the space to furnish, and/or on the same level (or floor) as the space to furnish. In such cases, the layout management component may identify the characteristics of such proximate spaces. The characteristics may include the types and/or styles of furniture included in such spaces. As noted, the machine learned models may use the characteristics to increase the consistency and/or cohesiveness of the spaces within the structure. That is, the style and/or furniture in the proximate space(s) may impact the furniture used in the recommended furnished space.

At operation 510, the layout management component may input the current configuration, criteria, and characteristics into a machine learned model. The online game may receive the trained machine learned models that were trained offline by the gaming system. In this case, the trained machine learned models may be generative machine learned models. Accordingly, the layout management component may input the current configuration, the criteria, and/or the characteristics of the proximate space(s) into the machine learned model which may be trained to output the furnished space. The machine learned model may be configured to analyze the various inputs and generate a recommend furnished space that conforms to the criteria and/or satisfies the request.

At operation 512, the layout management component may receive, from the machine learned model, a recommended furnished space. The output data can include the space type (or classification), the space dimension(s), the types (or classifications) of furniture included in the space, the size and/or dimension(s) of the furniture, the position and/or orientation of the furniture in the space, etc.

At operation 514, the layout management component may cause the recommended furnished space to be displayed via a user interface of a player or user device of a player. That is, the layout management component may display the furnished space to the requesting player. In some cases, the layout management component may use the output data from the machine learned model to know where and/or how to render the furnished space. In some cases, the furnished space may be displayed on the same or separate user interface from the user interface used to request the furnished space.

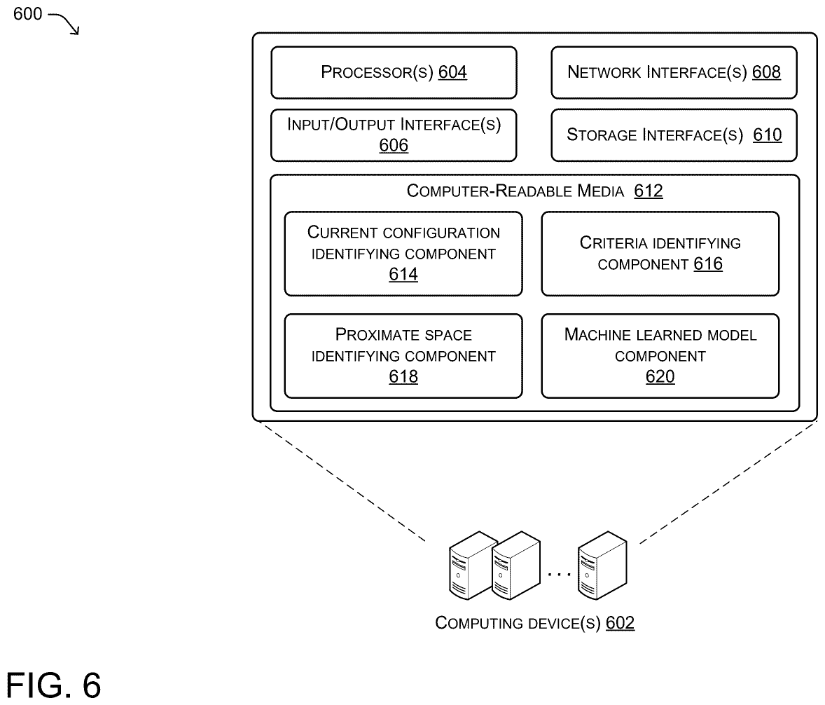

FIG. 6 illustrates a block diagram 600 of example computing device(s) 602 that may include a space creation game as described throughout. That is, the computing device(s) 602 may also be referred to as an online game. The computing device(s) 602 may include one or more processor(s) 604, one or more input/output (I/O) interface(s) 606, one or more network interface(s) 608, one or more storage interface(s) 610, and computer-readable media 612.

In some implementations, the processor(s) 604 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip system(s) (SOCs), complex programmable logic devices (CPLDs), etc. Additionally, each of the processor(s) 604 may possess its own local memory, which also may store program modules, program data, and/or one or more operating system(s). The one or more processor(s) 604 may include one or more cores.

The one or more input/output (I/O) interface(s) 606 may enable the computing device(s) 602 to detect interaction with a user and/or other system(s), such as one or more game system(s). The I/O interface(s) 606 may include a combination of hardware, software, and/or firmware and may include software drivers for enabling the operation of any variety of I/O device(s) integrated on the computing device(s) 602 or with which the computing device(s) 602 interacts, such as displays, microphones, speakers, cameras, switches, and any other variety of sensors, or the like.

The network interface(s) 608 may enable the computing device(s) 602 to communicate via the one or more network(s). The network interface(s) 608 may include a combination of hardware, software, and/or firmware and may include software drivers for enabling any variety of protocol-based communications, and any variety of wireline and/or wireless ports/antennas. For example, the network interface(s) 608 may comprise one or more of a cellular radio, a wireless (e.g., IEEE 802.1x-based) interface, a Bluetooth® interface, and the like. In some embodiments, the network interface(s) 608 may include radio frequency (RF) circuitry that allows the computing device(s) 602 to transition between various standards. The network interface(s) 608 may further enable the computing device(s) 602 to communicate over circuit-switch domains and/or packet-switch domains.

The storage interface(s) 610 may enable the processor(s) 604 to interface and exchange data with the computer-readable media 612, as well as any storage device(s) external to the computing device(s) 602.

The computer-readable media 612 may include volatile and/or nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable read-only memory (EEPROM), flash memory or other memory technology, CD-ROM, digital versatile discs (DVD) or other optical storage, magnetic cassettes, magnetic tape, magnetic disk storage or other magnetic storage devices, RAID storage system(s), or any other medium which can be used to store the desired information and which can be accessed by a computing device. The computer-readable media 612 may be implemented as computer-readable storage media (CRSM), which may be any available physical media accessible by the processor(s) 604 to execute instructions stored on the computer-readable media 612. In one basic implementation, CRSM may include RAM and Flash memory. In other implementations, CRSM may include, but is not limited to, ROM, EEPROM, or any other tangible medium which can be used to store the desired information and which can be accessed by the processor(s) 604. The computer-readable media 612 may have an operating system (OS) and/or a variety of suitable applications stored thereon. The OS, when executed by the processor(s) 604 may enable management of hardware and/or software resources of the computing device(s) 602.

Several functional blocks having instruction, data stores, and so forth may be stored within the computer-readable media 612 and configured to execute on the processor(s) 604. The computer-readable media 612 may have stored thereon a current configuration identifying component 614, a criteria identifying component 616, a proximate space identifying component 618, and/or a machine learned model component 620.

In some examples, the current configuration identifying component 614, the criteria identifying component 616, the proximate space identifying component 618, and/or the machine learned model component 620 may perform similar operations as those described with respect to the layout management component 202 in FIGS. 1-5.

The illustrated aspects of the claimed subject matter may also be practiced in distributed computing environments where certain tasks are performed by remote processing devices that are linked through a communications network. In a distributed computing environment, program modules can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. As an example, embodiments of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### Example Clauses

A: A system comprising: one or more processors; and one or more non-transitory computer-readable media storing computer-executable instructions that, when executed, cause the system to perform operations comprising: receiving, from a player device interacting with an online game and associated with a player, a request to furnish a space; identifying, in response to the request, a current configuration of the space; receiving, based at least in part on the request, criteria associated with furnishing the space; identifying a proximate space to the space; identifying a characteristic of the proximate space; inputting the current configuration, the criteria, and the characteristic into a machine learned model; receiving, from the machine learned model, output data representative of a recommended furnished space; and causing, in response to receiving the output data, the recommended furnished space to be displayed by the player device.

B: The system of paragraph A, wherein the proximate space is proximate to the space based at least in part on at least one of: determining that the proximate space is within a threshold distance from the space; or determining that the proximate space is on a same level of a structure as the space.

C: The system of paragraph A, wherein inputting the current configuration, the criteria, and the characteristic into the machine learned model is based at least in part on: determining, based at least in part on the request, a classification of the space; identifying a plurality of machine learned models trained to generate furnished layouts; and determining, from the plurality of machine learned models, that the machine learned model is associated with the classification, wherein inputting the current configuration, the criteria, and the characteristic into the machine learned model is based at least in part on the machine learned model being associated with the classification.

D: The system of paragraph A, wherein the current configuration includes at least one of: a dimension or a ratio of the space, a location of a door or an aperture in the space, a type of furniture in the space, a size of the furniture in the space, a dimension of the furniture in the space, a ratio of the furniture in the space, a location of the furniture in the space, or an orientation of the furniture in the space.

E: The system of paragraph A, wherein the criteria includes at least one of: a furnishing style, a budget associated with furnishing the space, a priority of furniture in the space based on a classification of the space, a quantity of furniture pieces in the space, a requested type of furniture to include in the space, or a furnishing rule associated with the space.

F: One or more non-transitory computer-readable media storing instructions executable by one or more processors, wherein the instructions, when executed, cause a system to perform operations comprising: receiving, from a player device interacting with an online game and associated with a player, a request to furnish a space; identifying, in response to the request, a current configuration of the space; receiving, based at least in part on the request, criteria associated with furnishing the space; inputting the current configuration and the criteria into a machine learned model; receiving, from the machine learned model, output data representative of a recommended furnished space; and causing, in response to receiving the output data, the recommended furnished space to be displayed the player device.

G: The one or more non-transitory computer-readable media of paragraph F, wherein the recommended furnished space is further based at least in part on: identifying a proximate space to the space; and identifying a characteristic of the proximate space, wherein receiving the recommended furnished space is further based at least in part on inputting the characteristic into the machine learned model.

H: The one or more non-transitory computer-readable media of paragraph G, wherein the proximate space is proximate to the space based at least in part on at least one of: determining that the proximate space is within a threshold distance from the space; or determining that the proximate space is on a same level of a structure as the space.

I: The one or more non-transitory computer-readable media of paragraph F, wherein inputting the current configuration and the criteria into the machine learned model is based at least in part on: determining, based at least in part on the request, a classification of the space; identifying a plurality of machine learned models trained to generate furnished layouts; and determining, from the plurality of machine learned models, that the machine learned model is associated with the classification, wherein inputting the current configuration and the criteria into the machine learned model is based at least in part on the machine learned model being associated with the classification.

J: The one or more non-transitory computer-readable media of paragraph F, wherein the current configuration includes at least one of: a dimension or a ratio of the space, a location of a door or an aperture in the space, a type of furniture in the space, a size of the furniture in the space, a dimension of the furniture in the space, a ratio of the furniture in the space, a location of the furniture in the space, or an orientation of the furniture in the space.

K: The one or more non-transitory computer-readable media of paragraph F, wherein the criteria includes at least one of: a furnishing style, a budget associated with furnishing the space, a priority of furniture in the space based on a classification of the space, a quantity of furniture pieces in the space, a requested type of furniture to include in the space, or a furnishing rule associated with the space.

L: The one or more non-transitory computer-readable media of paragraph F, the operations further comprising: receiving a second request to modify the recommended furnished space; receiving a rule associated with the recommended furnished space; determining that the second request satisfies the rule; and causing, based at least in part on the second request satisfying the rule, a modification to the recommended furnished space.

M: The one or more non-transitory computer-readable media of paragraph F, wherein the output data includes at least one of: a classification of the space, a dimension of the space, a classification of furniture included in the space, a size of the furniture, a dimension of the furniture in the space, a position of the furniture within the space, or an orientation of the furniture within the space.

N: A method comprising: receiving, from a player device interacting with an online game and associated with a player, a request to furnish a space; identifying, in response to the request, a current configuration of the space; receiving, based at least in part on the request, criteria associated with furnishing the space; inputting the current configuration and the criteria into a machine learned model; receiving, from the machine learned model, output data representative of a recommended furnished space; and causing, in response to receiving the output data, the recommended furnished space to be displayed the player device.

O: The method of paragraph N, wherein the recommended furnished space is further based at least in part on: identifying a proximate space to the space; and identifying a characteristic of the proximate space, wherein receiving the recommended furnished space is further based at least in part on inputting the characteristic into the machine learned model.

P: The method of paragraph O, wherein the proximate space is proximate to the space based at least in part on at least one of: determining that the proximate space is within a threshold distance from the space; or determining that the proximate space is on a same level of a structure as the space.

Q: The method of paragraph N, wherein inputting the current configuration and the criteria into the machine learned model is based at least in part on: determining, based at least in part on the request, a classification of the space; identifying a plurality of machine learned models trained to generate furnished layouts; and determining, from the plurality of machine learned models, that the machine learned model is associated with the classification, wherein inputting the current configuration and the criteria into the machine learned model is based at least in part on the machine learned model being associated with the classification.

R: The method of paragraph N, wherein the current configuration includes at least one of: a dimension or a ratio of the space, a location of a door or an aperture in the space, a type of furniture in the space, a size of the furniture in the space, a dimension of the furniture in the space, a ratio of the furniture in the space, a location of the furniture in the space, or an orientation of the furniture in the space.

S: The method of paragraph N, wherein the criteria includes at least one of: a furnishing style, a budget associated with furnishing the space, a priority of furniture in the space based on a classification of the space, a quantity of furniture pieces in the space, a requested type of furniture to include in the space, or a furnishing rule associated with the space.

T: The method of paragraph N, further comprising: receiving a second request to modify the recommended furnished space; receiving a rule associated with the recommended furnished space; determining that the second request satisfies the rule; and causing, based at least in part on the second request satisfying the rule, a modification to the recommended furnished space.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing computer-executable instructions that, when executed, cause the system to perform operations comprising:
receiving, from a player device interacting with an online game and associated with a player, a request to furnish a space;
identifying, in response to the request, a current configuration of the space;
receiving, based at least in part on the request, criteria associated with furnishing the space;
identifying a proximate space to the space;
identifying a characteristic of the proximate space;
inputting the current configuration, the criteria, and the characteristic into a machine learned model;
receiving, from the machine learned model, output data representative of a recommended furnished space; and
causing, in response to receiving the output data, the recommended furnished space to be displayed by the player device.

2. The system of claim 1, wherein the proximate space is proximate to the space based at least in part on at least one of:
determining that the proximate space is within a threshold distance from the space; or
determining that the proximate space is on a same level of a structure as the space.

3. The system of claim 1, wherein inputting the current configuration, the criteria, and the characteristic into the machine learned model is based at least in part on:
determining, based at least in part on the request, a classification of the space;
identifying a plurality of machine learned models trained to generate furnished layouts; and
determining, from the plurality of machine learned models, that the machine learned model is associated with the classification, wherein inputting the current configuration, the criteria, and the characteristic into the machine learned model is based at least in part on the machine learned model being associated with the classification.

4. The system of claim 1, wherein the current configuration includes at least one of:
a dimension or a ratio of the space,
a location of a door or an aperture in the space,
a type of furniture in the space,
a size of the furniture in the space,
a dimension of the furniture in the space,
a ratio of the furniture in the space,
a location of the furniture in the space, or
an orientation of the furniture in the space.

5. The system of claim 1, wherein the criteria includes at least one of:
a furnishing style,
a budget associated with furnishing the space,
a priority of furniture in the space based on a classification of the space,
a quantity of furniture pieces in the space,
a requested type of furniture to include in the space, or
a furnishing rule associated with the space.

6. One or more non-transitory computer-readable media storing instructions executable by one or more processors, wherein the instructions, when executed, cause a system to perform operations comprising:
receiving, from a player device interacting with an online game and associated with a player, a request to furnish a space;
identifying, in response to the request, a current configuration of the space;
receiving, based at least in part on the request, criteria associated with furnishing the space;
inputting the current configuration and the criteria into a machine learned model;
receiving, from the machine learned model, output data representative of a recommended furnished space; and
causing, in response to receiving the output data, the recommended furnished space to be displayed by the player device.

7. The one or more non-transitory computer-readable media of claim 6, wherein the recommended furnished space is further based at least in part on:
identifying a proximate space to the space; and
identifying a characteristic of the proximate space, wherein receiving the recommended furnished space is further based at least in part on inputting the characteristic into the machine learned model.

8. The one or more non-transitory computer-readable media of claim 7, wherein the proximate space is proximate to the space based at least in part on at least one of:
determining that the proximate space is within a threshold distance from the space; or
determining that the proximate space is on a same level of a structure as the space.

9. The one or more non-transitory computer-readable media of claim 6, wherein inputting the current configuration and the criteria into the machine learned model is based at least in part on:
determining, based at least in part on the request, a classification of the space;
identifying a plurality of machine learned models trained to generate furnished layouts; and
determining, from the plurality of machine learned models, that the machine learned model is associated with the classification, wherein inputting the current configuration and the criteria into the machine learned model is based at least in part on the machine learned model being associated with the classification.

10. The one or more non-transitory computer-readable media of claim 6, wherein the current configuration includes at least one of:
a dimension or a ratio of the space,
a location of a door or an aperture in the space,
a type of furniture in the space,
a size of the furniture in the space,
a dimension of the furniture in the space,
a ratio of the furniture in the space,
a location of the furniture in the space, or
an orientation of the furniture in the space.

11. The one or more non-transitory computer-readable media of claim 6, wherein the criteria includes at least one of:
a furnishing style,
a budget associated with furnishing the space,
a priority of furniture in the space based on a classification of the space,
a quantity of furniture pieces in the space,
a requested type of furniture to include in the space, or
a furnishing rule associated with the space.

12. The one or more non-transitory computer-readable media of claim 6, the operations further comprising:
receiving a second request to modify the recommended furnished space;
receiving a rule associated with the recommended furnished space;
determining that the second request satisfies the rule; and
causing, based at least in part on the second request satisfying the rule, a modification to the recommended furnished space.

13. The one or more non-transitory computer-readable media of claim 6, wherein the output data includes at least one of:
a classification of the space,
a dimension of the space,
a classification of furniture included in the space,
a size of the furniture,
a dimension of the furniture in the space,
a position of the furniture within the space, or
an orientation of the furniture within the space.

14. A method comprising:
receiving, from a player device interacting with an online game and associated with a player, a request to furnish a space;
identifying, in response to the request, a current configuration of the space;
receiving, based at least in part on the request, criteria associated with furnishing the space;
inputting the current configuration and the criteria into a machine learned model;
receiving, from the machine learned model, output data representative of a recommended furnished space; and
causing, in response to receiving the output data, the recommended furnished space to be displayed by the player device.

15. The method of claim 14, wherein the recommended furnished space is further based at least in part on:
identifying a proximate space to the space; and
identifying a characteristic of the proximate space, wherein receiving the recommended furnished space is further based at least in part on inputting the characteristic into the machine learned model.

16. The method of claim 15, wherein the proximate space is proximate to the space based at least in part on at least one of:
determining that the proximate space is within a threshold distance from the space; or
determining that the proximate space is on a same level of a structure as the space.

17. The method of claim 14, wherein inputting the current configuration and the criteria into the machine learned model is based at least in part on:
determining, based at least in part on the request, a classification of the space;
identifying a plurality of machine learned models trained to generate furnished layouts; and
determining, from the plurality of machine learned models, that the machine learned model is associated with the classification, wherein inputting the current configuration and the criteria into the machine learned model is based at least in part on the machine learned model being associated with the classification.

18. The method of claim 14, wherein the current configuration includes at least one of:
a dimension or a ratio of the space,
a location of a door or an aperture in the space,
a type of furniture in the space,
a size of the furniture in the space,
a dimension of the furniture in the space,
a ratio of the furniture in the space,
a location of the furniture in the space, or
an orientation of the furniture in the space.

19. The method of claim 14, wherein the criteria includes at least one of:
a furnishing style,
a budget associated with furnishing the space,
a priority of furniture in the space based on a classification of the space,
a quantity of furniture pieces in the space,
a requested type of furniture to include in the space, or
a furnishing rule associated with the space.

20. The method of claim 14, further comprising:
receiving a second request to modify the recommended furnished space;
receiving a rule associated with the recommended furnished space;
determining that the second request satisfies the rule; and
causing, based at least in part on the second request satisfying the rule, a modification to the recommended furnished space.
